(19) United States
(12) Patent Application Publication
(10) Pub. No.: US 2012/0304911 A1
(43) Pub. Date: Dec. 6, 2012

(54) ACTIVE CONTROL SYSTEM FOR FLOATING OFFSHORE WIND TURBINE PLATFORMS

(75) Inventor: TIMOTHY J. McCOY, CROFTON, MD (US)

(73) Assignee: CONVERTEAM NAVAL SYSTEMS, INC., RUGBY (GB)

(21) Appl. No.: 13/118,812

(22) Filed: May 31, 2011

(51) Int. Cl. B63B 21/50; G06F 19/00; B63B 35/44; B63B 21/00

(52) U.S. Cl. 114/264; 114/230.1; 701/21; 114/293

(57) ABSTRACT

A dynamic anchoring system for use in stabilizing a floating platform is provided. The dynamic anchoring system includes a mooring assembly having a plurality of rodes each with an adjustable length. As waves cause the platform to rock, the length of each rode is adjusted in a manner to counteract the motion created by the waves. Thus, the platform remains substantially level. The platform supports a wind turbine on a mast. At least one motion sensor on the mast provides motion data indication the direction and speed of the hull's motion.

### BACKGROUND OF THE INVENTION

1. Field of the Invention

The disclosed and claimed concept relates to an active control system for a mooring assembly on an offshore platform and, more specifically, to an active control system structured to substantially level the floating platform.

2. Background Information

Wind turbines assemblies are used to generate electricity while having a reduced impact on the environment relative to electricity generated from fossil fuels. As with many electrical systems, people like receiving the electricity, but do not want to have the means for generating the electricity near their homes or businesses. Further, wind turbines assemblies must be located where there is an adequate amount of wind to power the turbine. Offshore locations are, generally, not near people and have an adequate amount of wind. Thus, wind turbines assemblies may be advantageously located offshore. If the water is shallow, the wind turbine assemblies may be fixed to the seabed.

One problem with floating platforms is that such platforms rock in response to environmental conditions, i.e. waves and wind. Further, a horizontal axis wind turbine assembly includes a blade assembly, a wind turbine, and a mast. The blade assembly is coupled to the wind turbine and rotates in response to the wind. The turbine is located on top of the mast, and is typically disposed in a protective housing called a nacelle. The mast must have a height sufficient to ensure that the blades do not impact the platform or the sea. Further, taller masts are advantageous as wind speeds typically increase with altitude. Masts are typically between 50 and 150 meters in height. When a horizontal axis wind turbine assembly is mounted on a floating platform, the horizontal axis wind turbine assembly may, and almost certainly will, be subjected to environmental motion. That is, waves in ocean cause the platform to rock. This motion is amplified by the arm created by the mast. In other words, a small motion at the platform typically becomes a large motion near the top of the mast. Further, given that the wind turbine located near the top of the mast is very heavy, this motion creates a great deal of stress over the length of the mast and at the coupling between the mast and the platform. Further, if the nacelle moves too far from a location above the platform's center of gravity, the platform may tip over. It is desirable to reduce this stress for safety reasons and so that the mast and various coupling components may be made lighter and, typically, less expensively.

It is further noted that many offshore wind turbine platforms utilize submerged or semi-submerged platforms as such platforms tend to be less influenced by wave activity. Such submerged platforms are, however, generally more expensive to build and maintain. Further, such platforms, as well as some floating platforms, are designed with reduced cross-sectional areas, e.g. catamaran hulls or spoke-like frames, often with buoys disposed at the tips of the spokes, see U.S. Pat. No. 7,156,586. These complex hull shapes are also intended to reduce the impact of waves on the motion of the hull as compared to a rectangular hull structured to support about the same weight. These structures are also generally more expensive to build and maintain than a simple generally rectangular hull.

### SUMMARY OF THE INVENTION

The disclosed and claimed concept provides for a dynamic anchoring system for use in stabilizing a floating platform. The dynamic anchoring system includes a mooring assembly having a plurality of rodes each with an adjustable length. As waves cause the platform to rock, the length of each rode is adjusted in a manner to counteract the motion created by the waves. Thus, the platform remains substantially level.

The platform is a hull, preferably, a barge-like hull, and is structured to support a wind turbine. The wind turbine is, preferably, a horizontal axis wind turbine assembly having a mast. As noted above, given the height of a typical wind turbine mast, even slight rocking motions at the platform result in considerable motion at the top of the mast. Thus, if the platform remains substantially level, the motion of the wind turbine at the top of the mast is reduced. That is, the dynamic anchoring system dampens the motion of the wind turbine nacelle located near the top of the mast.

The dynamic anchoring system is, preferably, structured to respond, essentially, immediately to the existing motion at the nacelle. That is, the dynamic anchoring system includes a motion sensor disposed on the nacelle or near the top of the mast. The sensor provides data indicating the direction in which the mast is moving. This data is provided to a control system. The control system controls a plurality of powered windlasses which are part of the mooring assembly. The windlasses adjust the length of the rodes as required to effect the desired stabilization of the platform.

### BRIEF DESCRIPTION OF THE DRAWINGS

A full understanding of the invention can be gained from the following description of the preferred embodiments when read in conjunction with the accompanying drawings in which:

FIG. 1 is a schematic side view of an offshore wind turbine platform.

FIG. 2 is a schematic top view of an offshore wind turbine platform.

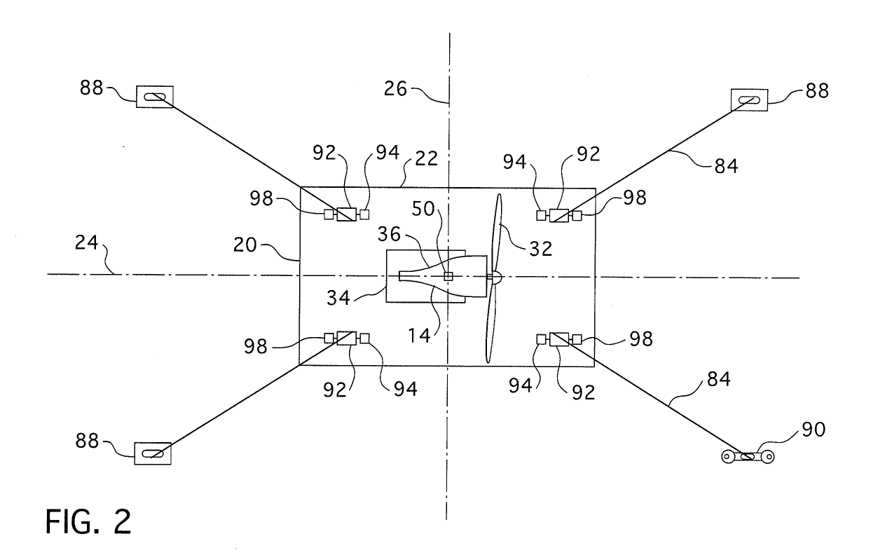

### DESCRIPTION OF THE PREFERRED EMBODIMENTS

As used herein, “coupled” means a link between two or more elements, whether direct or indirect, so long as a link occurs.

As used herein, “directly coupled” means that two elements are directly in contact with each other.

As used herein, “fixedly coupled” or “fixed” means that two components are coupled so as to move as one while maintaining a constant orientation relative to each other.

As used herein, “seabed” means any substrate located below a body of water.

As used herein, “environmental motion” is the motion imparted to a floating object by wind and waves.

As used herein, “actively stabilize” means that a stabilizing motion is imparted to the element being stabilized rather than simply attempting to resist any environmental motion.

As used herein, the phrase “tension member” means a member capable of supporting a load while in tension, but which is generally flexible under a compressive force.

As used herein, when referring to the transmission of power, “electrical communication” means a hard-line connection via a conductor.

As used herein, when referring to the transmission of information via an electrical signal, “electrical communication” means either, or a combination of a hard-line connection via a conductor or a wireless signal.

As used herein, a “PLC” means a programmable logic control such as an integrated circuit or any similar device.

As used herein, a “windlass” includes capstans, that is, the windlass drum may have a vertical or horizontal axis.

As used herein, “sensors” includes virtual sensors created by mathematical models embedded in a sensor controller or other sensor electronics.

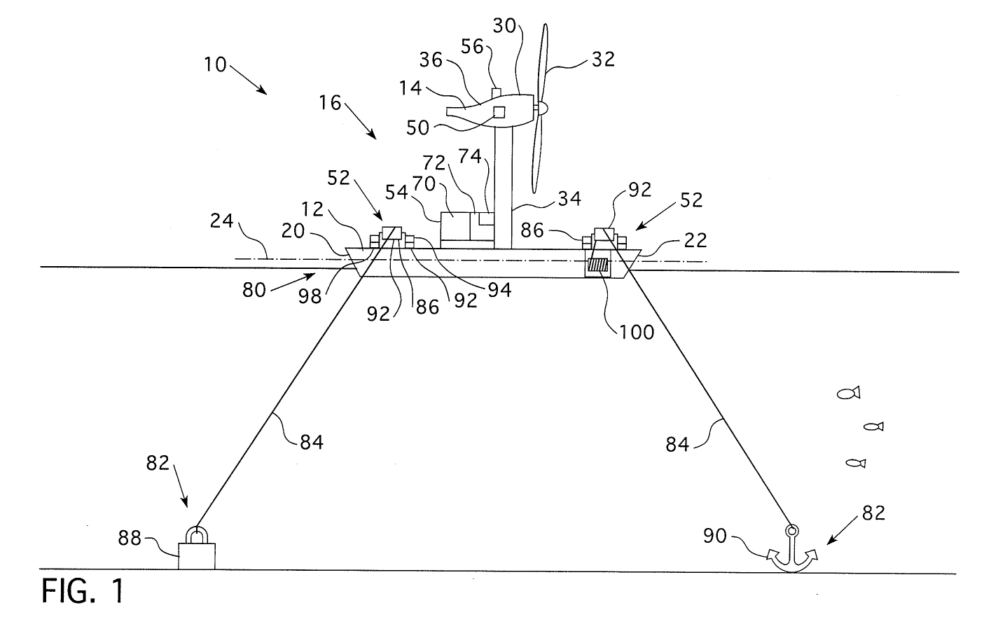

As shown in FIG. 1, an offshore wind turbine platform 10 includes a floating platform 12, a wind turbine assembly 14 and a dynamic anchoring system 16. The floating platform 12 is preferably a barge 20 having a generally rectangular hull 22 which is structured to float on the surface of the water. The barge 20 may include various common components that are not relevant to the present concept, such as, but not limited to an enclosure, safety devices, and a lighting system (none shown). The barge 20 is structured to support the wind turbine assembly 14. Typically, if there is a single wind turbine assembly, it is fixed to the hull 22 at a central location.

The wind turbine assembly 14, preferably, has a horizontal axis wind turbine 30, a blade assembly 32, and a mast 34. The horizontal axis wind turbine 30 is, typically, disposed in a protective housing or nacelle 36. The nacelle 36 is disposed at, or near, the distal, top end of the mast 34. The mast 34 typically has a height between about 50 and 150 meters. The hull 22 and the wind turbine assembly 14 are subjected to environmental motion from the wind and the waves. That is, the hull 22 and the wind turbine assembly 14 tend to rock and sway in response to the wind and waves. Because the nacelle 36 is disposed at the top of the tall mast 34, even slight movement at sea level become exaggerated, long movement at the nacelle 36. As the hull 22 is generally rectangular, the hull 22 has a longitudinal axis 24 and a lateral axis 26. As used herein, “roll” means a rocking motion about the hull 22 longitudinal axis 24 and “pitch” means a rocking motion about the hull 22 lateral axis 26. The hull 22 may also spin, or yaw, about a vertical axis, but that motion does not cause the nacelle 36 to move relative to the platform 12 center of gravity and, as such, is not as much of a concern as the roll and pitch of the hull 22.

The dynamic anchoring system 16 is structured to actively stabilize the floating platform 12 and thereby dampen the motion of the nacelle 36. The dynamic anchoring system 16 includes at least one motion sensor 50, a mooring assembly 52, and a control system 54. The at least one motion sensor 50 is mounted on, or near the nacelle 36. The at least one motion sensor 50 may be a gyroscope, an accelerometer, or any other sensor structured to detect motion and produce data representing the motion. The at least one motion sensor 50 may include two or more sensors 50 wherein each sensor is structured to detect the motion of the nacelle 36 relative to either the hull longitudinal axis 24 or lateral axis 26. Thus, the at least one motion sensor 50 is structured to measure the nacelle 36 motion and transmit a motion signal incorporating data representing the nacelle 36 motion. The at least one motion sensor 50 may transmit the motion signal wirelessly to the control system 54, or, may be coupled by a hardwire to the control system 54.

The control system 54 is in electrical communication, by hard line or wireless communication devices, with the motion sensor 50 and the mooring assembly 52. The control system 54 is structured to receive the motion signal from the sensor 50 and to provide a command signal to the mooring assembly 52. The control system 54 may be generally described as “computerized” and includes a programmable logic circuit (PLC) 70 (shown schematically) which is typically a computer processor. The control system 54 further includes an electronic storage device 72 and a feedback routine 74 (each shown schematically). The electronic storage device 72 may be one or more of a hard drive, optical drive, flash memory, RAM, or ROM. The feedback routine 74 is a set of instructions structured to be stored in the electronic storage device 72 and executed by the PLC 70. The feedback routine 74 is further structured to receive the motion signal and the data representing the motion of the nacelle 36. The feedback routine 74 further calculates the change in length of each rode 84 (discussed below) required to substantially level the hull 22. The change in length measurement for each rode 84, the direction of the change (i.e. extended or retracted), and the speed at which the adjustment needs to be made are recorded as adjustment data. The feedback routine 74 incorporates the adjustment data into the command signal provided to the mooring assembly 52 as discussed below.

While any coordinate system may be used, the feedback routine 74, preferably, uses Cartesian coordinates or spherical coordinates. That is, the feedback routine 74 is structured to convert the data representing the nacelle motion into coordinate data, the coordinate system selected from the group including Cartesian coordinates and spherical coordinates. For example, if data is processed in Cartesian coordinates, the feedback routine 74 is structured to convert the data representing the nacelle 36 motion into data representing motion about a roll axis (i.e. the longitudinal axis of the hull 22) and motion about a pitch axis (i.e. the lateral axis of the hull 22). This embodiment works cooperatively with the embodiment of the at least one sensor 50 having two sensors 50 wherein each sensor is structured to detect the motion of the nacelle 36 relative to either the hull longitudinal axis 24 or lateral axis 26. In this configuration, the feedback routine 74 is structured to process multiple input and multiple outputs, i.e. the feedback routine 74 is a MIMO routine. Further, so as to accept the multiple inputs and outputs, the PLC 70 is a MIMO controller. If data is processed in spherical coordinates, the feedback routine 74 is structured to convert data representing the nacelle 36 motion into spherical coordinate data wherein the origin of the coordinate system is the base of the mast 34.

It is noted that as the effective length of each rode 84 is adjusted (as discussed below), the motion of the nacelle 36 changes. This change in the nacelle 36 motion is detected by the sensor 50 and the updated motion data is provided to the control system 54 which then responds to the updated motion data. This process is repeated until the nacelle 36 is substantially still. Given the fact that the environmental motion will almost always impact the hull 22, however, the dynamic anchoring system 16 is likely to be in almost constant operation.

Generally, the mooring assembly 52 includes a plurality of rodes 84 extending between the hull 22 and an anchor point 84. Each rode 84 has an adjustable length. That is, the “effective length” of the rode 84 means the length currently in use and does not refer to any portion of the rode 84 wound about a spool or stored in a locker or other chamber. As discussed below, the mooring assembly 52 is further structured to determine the change in effective length of each rode 84 relative to a neutral position (described below). A measurement representing the change in effective length of each rode 84 is converted to representative data. The mooring assembly 52 is further structured to transmit data representing each change in the effective length of each rode 84 relative to a neutral position to the control system 54.

More specifically, the mooring assembly 52 includes at least three anchor assemblies 80, and preferably four anchor assemblies 80. Each anchor assembly 80 has an anchor point 82, a rode 84, and a windlass 86. The anchor point 82 may be a fixed anchor 88 on the seabed or may be a retractable anchor 90 that is in use. Although both types of anchor points are shown in the Figure, typically only one type will be used on a single offshore wind turbine platform 10.

Each rode 84 is typically a chain or a cable but may be any type of tension member. Each rode 84 is coupled to either a fixed anchor 88 on the seabed or a retractable anchor 90. Each rode 84 further engages a windlass 86. Thus, the “effective length” of the rode 84 is the portion of the rode 84 extending between the anchor point 82 and the windlass 86, and more specifically, the windlass drum 92 (discussed below).

Each windlass 86 is fixed to the hull 22. Each windlass 86 includes a rotating drum 92, a motor 94, an electrical control system 96, a rode sensor 98, and a storage device 100. Each drum 92 is, typically, a wheel or sprocket disposed on horizontal axis. Each rode 84 passes over and a portion of the rode 84 engages the associated drum 92. That is, each rode 84 “engages” the associated drum 92 so that when the drum 92 rotates, the rode 84 moves therewith. For example, if the rode 84 is a chain and the drum 92 is a sprocket, the teeth of the sprocket “engage” the links in the chain. Thus, as each drum 92 rotates, the associated rode 84 is drawn up or let out (hereinafter and collectively “adjusted”). The portion of the rode 84 on the ship side of the drum 92 is passed into the storage device 100. Typically, the storage device 100 is a compartment on the barge 20 or a spool (not shown). Each windlass motor 94, which is preferably an electric motor, is structured to rotate the associated drum 92 so as to adjust the associated rode 84. Each windlass electrical control system 96 is structured to control the associated electrical motor 94 and to receive the command signal from the control system 54. The command signal instructs each windlass electrical control system 96 at whether the windlass motor 94 should be directed to draw up or let out the associated rode 84. The amount of the rode 84 to be adjusted and the speed at which the windlass motor 94 should be operated are determined by the feedback routine 74.

It is further noted that because the windlass 86, and therefore the drum 92, are fixed to the hull 22, the location where the rode 84 engages the drum 92 is effectively the location where the rode 84 is coupled to the hull 22, i.e. the rode hull coupling point 85. While understanding that the rode 84 and the drum 92 move, the rode hull coupling point 85 is fixed. That is, no matter what portion of the rode 84 engages the drum 92, or what orientation the drum 92 is in, the point where the rode 84 engages the drum 92 remains substantially fixed relative to the hull 22.

The rode sensor 98 is structured to track the position of the rode 84 relative to a neutral location (discussed below). As the rode 84 is, typically, non-elastic, this may be accomplished by measuring the length of the rode 84 that passes over the drum 92 when the rode 84 is either extended or retracted. Such a measurement may be accomplished by any well known method, including, but not limited to, counting the revolutions of the drum 92 multiplied by the circumference of the drum 92. In this manner, the rode sensor 98 detects and tracks the effective length of the rode 84.

In operation, the offshore wind turbine platform 10 with the dynamic anchoring system 16 operates as follows. The barge 20 is positioned over the fixed anchor 88 positions, or, if retractable anchors 90 are used, the retractable anchors 90 are dropped. Preferably, the anchor points 82 will be located at positions outside, i.e. not directly underneath, the hull 22. The rodes 84 are placed under tension. It is noted that when four anchor assemblies 80 are used, rotation of the barge 20 about a vertical axis (yaw) is substantially prevented. When the mast 34 is substantially vertical, a neutral location on each rode 84 may be established. The “neutral location” is, for example, the configuration of each rode 84 at an optimal effective length such as when the offshore wind turbine platform 10 is on calm water and the mast 34 is substantially vertical. Tracking of each rode's 84 effective length may be compared to this neutral location. For example, if a rode 84 is extended twenty feet relative to the neutral location, that rode 84 be said to be at +20 feet. Conversely, when a rode 84 is retracted twenty feet relative to the neutral location, that rode 84 is said to be at −20 feet.

When the hull 22 is subjected to environmental motion, the hull 22 and the mast 34 rotate about one or both, and typically both, the longitudinal and lateral axes 24, 26 of the barge 20. This motion is detected by the at least one motion sensor 50 disposed on, or near, the nacelle 36. The at least one motion sensor 50 transmits the motion signal incorporating data representing the nacelle 36 motion to the control system 54. The control system 54, and more specifically the feedback routine 74 calculates which rodes 84 need to be adjusted, the amount the effective length of the each rode 84 needs to be adjusted, the direction of the adjustment, and the speed at which the adjustment must occur, so as to substantially counteract the environmental motion. This data, the adjustment data, is incorporated into the command signal and transmitted to the mooring assembly 52 and, more specifically, to each windlass electrical control system 96. Each windlass electrical control system 96 then actuates the associated motor 94 so as to effect the desired change in the effective length of the associated rode 84. As noted above, as the motion of the nacelle 36 is effected by the mooring assembly 52, updated motion data is provided to the control system 54 and the process repeats itself. This occurs until the mast 34 is returned to a substantially vertical orientation. Again as noted above, as environmental motion is almost constantly being imparted to the barge 20, this process may be continuous. That is, the mast 34 may rarely, or never, return to a stationary, substantially vertical orientation.

It is further noted that the manner in which the feedback routine 74 determines the desired adjustment for each rode 84 may be accomplished by at least two different methods. First, if the anchor points 82 are fixed anchors 88 on the seabed, the geometry of the mooring assembly 52 may be established. That is, as the anchor points 82 are fixed and the coupling point between each rode 84 and the hull 22 is fixed, as detailed above, and as the effective length of each rode 84 may be determined, a geometric model may be established that reflects the configuration of the mooring assembly 52. Further, because the mast 34 is fixed to the hull 22, when environmental motion causes the nacelle 36 to move, the orientation of the hull 22 may tracked as well via the at least one motion sensor 50 motion data. Knowing the orientation of the hull 22, the fixed location of the anchor points 82, the fixed position of the rode/hull 84/22 coupling point and the effective length of each rode 84, as well as the speed at which the nacelle 36 (and therefore the hull 22) is moving, the feedback routine 74 may be structured to perform a geometric analysis to determine the required adjustment of each rode 84 effective length to substantially level the hull 22.

Alternatively, and typically used when the rodes 84 are coupled to retractable anchors 90, the feedback routine 74 may be structured to heuristically determine the effect of the change of each rode 84 effective length relative to the plane, i.e. vertical orientation, of the hull 22. That is, when retractable anchors 90 are used, the resting position of the retractable anchors 90 on the seabed may be difficult to determine and, as such, a geometric analysis may be difficult as well. The feedback routine 74, however, may be programmed to track and compare various adjustments to the rodes 84 to determine how the adjustment of the mooring assembly 52 effects the motion of the nacelle 36. Through trial and error, the feedback routine 74 can be adapted to effectively counter the environmental motion imparted to the nacelle 36.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A dynamic anchoring system for use in stabilizing a floating platform, said floating platform having a hull and structured to support a wind turbine, said wind turbine having a mast and a nacelle, said mast fixed to said hull, said nacelle mounted near the top of said mast, said hull and said nacelle subjected to environmental motion, said dynamic anchoring system comprising:
at least one motion sensor structured to measure said nacelle motion and transmit a motion signal incorporating data representing said nacelle motion;
a mooring assembly coupled to said hull, said mooring assembly structured to actively orient said hull;
a control system in electrical communication with said motion sensor and said mooring assembly, said control system structured to receive said motion signal and to provide a command signal to said mooring assembly; and
said mooring assembly further structured to substantially level said hull in response to said command signal whereby said nacelle motion is dampened.

2. The anchoring system of claim 1 wherein:
said control system includes a PLC, an electronic storage device, and a feedback routine;
said feedback routine being stored in said electronic storage device and structured to be executed on said PLC;
said feedback routine further structured to receive said motion signal and the data representing the motion of said nacelle and to calculate the change in effective length of each rode required to substantially level said hull, the change in effective length measurement being recorded as adjustment data; and
said feedback routine further structured to incorporate said adjustment data into said command signal.

3. The anchoring system of claim 2 wherein said feedback routine is structured to convert said data representing said nacelle motion into coordinate data, said coordinate system selected from the group including Cartesian coordinates and spherical coordinates.

4. The anchoring system of claim 2 wherein said feedback routine is structured to convert said data representing said nacelle motion into data representing motion about a roll axis and motion about a pitch axis.

5. The anchoring system of claim 2 wherein:
said mooring assembly includes a plurality of rodes, each rode having an adjustable effective length;
said mooring assembly further structured to determine the change in effective length of each rode relative to a neutral position, said change in effective length of each rode being converted to representative data, said mooring assembly further structured to transmit data representing each said rode change in effective length of each rode relative to a neutral position to said control system; and
said feedback routine structured to heuristically determine the effect of the change of each rode effective length relative to the plane of said hull.

6. The anchoring system of claim 2 wherein:
said mooring assembly includes a plurality of rodes, each rode having an adjustable effective length;
each said rode having an anchor point and a coupling point with said hull;
each said rode hull coupling point being at a fixed position relative to said hull;
said rode anchor point being at a fixed position relative to the seabed; and
said feedback routine structured perform a geometric analysis to determine the required adjustment of each rode effective length to substantially level said hull.

7. The anchoring system of claim 2 wherein said at least one sensor is mounted on said nacelle.

8. The anchoring system of claim 2 wherein:
said mooring assembly includes at least three anchor assemblies, each anchor assembly having an anchor point, a rode, and a windlass;
each said windlass being fixed to said hull;
each said anchor point located on the seabed;
each rode extending between an anchor point and a windlass, each said rode having a portion of its length being stored by said windlass, whereby each rode has an adjustable effective length;
each said windlass structured to adjust the effective length of the associated rode; and
each said windlass structured to adjust the length of the associated rode in response to said command signal.

9. The anchoring system of claim 8 wherein:
each said windlass has a rotating drum, a motor, an electrical control system, and a rode sensor;
each said windlass electric motor coupled to the associated drum and structured to cause said drum to rotate;
each said windlass electrical control system structured to control the associated electrical motor and to receive said command signal; and
each said rode structured to engage the associated drum whereby the effective length of each said rode is adjusted.

10. The anchoring system of claim 9 wherein each said rode is under tension.

11. A floating platform comprising:
a generally rectangular hull structured to support a horizontal axis wind turbine;
said wind turbine having a mast, a wind turbine and a nacelle;
said mast fixed to said hull;
said wind turbine disposed in said nacelle;
said nacelle mounted near the top of said mast;
said hull and said nacelle being subjected to environmental motion;
a dynamic anchoring system having at least one motion sensor, a mooring assembly, and a control system;
said at least one motion sensor structured to measure said nacelle motion and transmit a motion signal incorporating data representing said nacelle motion;
said mooring assembly coupled to said hull, said mooring assembly structured to actively orient said hull;
said control system in electrical communication with said motion sensor and said mooring assembly, said control system structured to receive said motion signal and to provide a command signal to said mooring assembly; and
said mooring assembly further structured to substantially level said hull in response to said command signal whereby said nacelle motion is dampened.

12. The floating platform of claim 11 wherein:
said control system includes a PLC, an electronic storage device, and a feedback routine;
said feedback routine being stored in said electronic storage device and structured to be executed on said PLC;
said feedback routine further structured to receive said motion signal and the data representing the motion of said nacelle and to calculate the change in effective length of each rode required to substantially level said hull, the change in effective length measurement being recorded as adjustment data; and
said feedback routine further structured to incorporate said adjustment data into said command signal.

13. The floating platform of claim 12 wherein said feedback routine is structured to convert said data representing said nacelle motion into coordinate data, said coordinate system selected from the group including Cartesian coordinates and spherical coordinates.

14. The floating platform in of claim 12 wherein said feedback routine is structured to convert said data representing said nacelle motion into data representing motion about a roll axis and motion about a pitch axis.

15. The floating platform of claim 12 wherein:
said mooring assembly includes a plurality of rodes, each rode having an adjustable effective length;
said mooring assembly further structured to determine the change in effective length of each rode relative to a neutral position, said change in effective length of each rode being converted to representative data, said mooring assembly further structured to transmit data representing each said rode change in effective length of each rode relative to a neutral position to said control system; and
said feedback routine structured to heuristically determine the effect of the change of each rode effective length relative to the plane of said hull.

16. The floating platform of claim 12 wherein:
said mooring assembly includes a plurality of rodes, each rode having an adjustable effective length;
each said rode having an anchor point and a coupling point with said hull;
each said rode hull coupling point being at a fixed position relative to said hull;
said rode anchor point being at a fixed position relative to the seabed; and
said feedback routine structured perform a geometric analysis to determine the required adjustment of each rode effective length to substantially level said hull.

17. The floating platform of claim 12 wherein said at least one sensor is mounted on said nacelle.

18. The floating platform of claim 12 wherein:
said mooring assembly includes at least three anchor assemblies, each anchor assembly having an anchor point, a rode, and a windlass;
each said windlass being fixed to said hull;
each said anchor point located on the seabed;
each rode extending between an anchor point and a windlass, each said rode having a portion of its length being stored by said windlass, whereby each rode has an adjustable effective length;
each said windlass structured to adjust the effective length of the associated rode; and
each said windlass structured to adjust the length of the associated rode in response to said command signal.

19. The floating platform of claim 18 wherein:
each said windlass has a rotating drum, a motor, an electrical control system, and a rode sensor;
each said windlass electric motor coupled to the associated drum and structured to cause said drum to rotate;
each said windlass electrical control system structured to control the associated electrical motor and to receive said command signal; and
each said rode structured to engage the associated drum whereby the effective length of each said rode is adjusted.

20. The floating platform of claim 19 wherein each said rode is under tension.
